(19) United States
(12) Patent Application Publication
(10) Pub. No.: US 2014/0027598 A1
(43) Pub. Date: Jan. 30, 2014

(54) RECEPTACLE LIQUID EXTRACTOR

(71) Applicant: Amelia GIROL, Burlingame, CA (US)

(72) Inventor: Amelia GIROL, Burlingame, CA (US)

(21) Appl. No.: 13/561,022

(22) Filed: Jul. 28, 2012

(51) Int. Cl. A47G 29/00; F16B 47/00

(52) U.S. Cl. 248/346.03

(57) ABSTRACT

The present invention is a receptacle liquid extractor that includes a v-shaped oval base that receives a top portion of a bottle to removably secure the top portion of the bottle, where the bottle is in an inverted position to have a content of the bottle flow downward by gravity to the top portion of the bottle and a suction cup with a rounded top portion and a horizontal bottom portion, that stabilizes and secures the receptacle liquid extractor, the rounded top portion of the suction cup is attached to the bottom portion of the v-shaped oval base forming the receptacle liquid extractor. The horizontal bottom portion is horizontally flat and provides suction to an attachment surface and secures the receptacle liquid extractor to the attachment surface.

### TECHNICAL FIELD & BACKGROUND

Current options for liquid soap or lotion storage receptacles have a straight horizontal foundational base. This hinders utilization of the entire contents within the container and often requires the hassle of unscrewing a pump and shaking and turning the receptacle in an attempt to access any remaining liquid.

The present invention generally relates to an extractor. More specifically, the invention is a receptacle liquid extractor.

It is an object of the invention to provide a receptacle liquid extractor that holds a receptacle that contains a liquid, such as a bottle, in an inverted position indefinitely causing the liquid contained in the bottle to seep down into and through a top portion of the receptacle to be used as desired by a user.

It is an object of the invention to provide a receptacle liquid extractor that enables a user to save money by utilizing every amount of liquid contained in a receptacle.

It is an object of the invention to provide a receptacle liquid extractor that has a plurality of different dimensions to accommodate a plurality of different sized receptacles.

What is really needed is a receptacle liquid extractor that holds a receptacle that contains a liquid, such as a bottle, in an inverted position indefinitely causing the liquid contained in the bottle to seep down into and through a top portion of the receptacle to be used as desired by a user that enables a user to save money by utilizing every amount of liquid contained in a receptacle that has a plurality of different dimensions to accommodate a plurality of different sized receptacles.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a receptacle liquid extractor, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

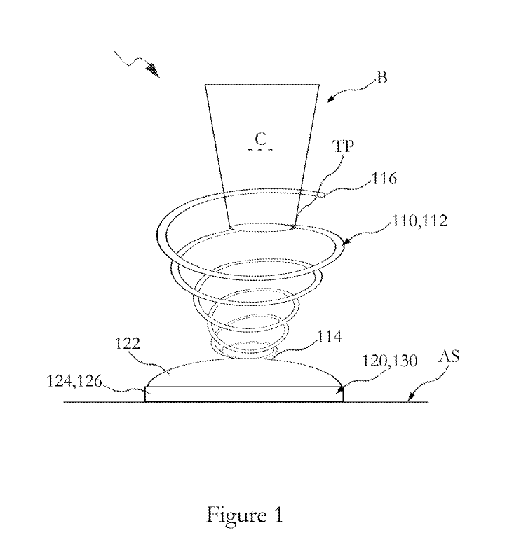

FIG. 1 illustrates an environmental front view of a receptacle liquid extractor 100, according to an embodiment of the present invention.

The receptacle liquid extractor 100 includes a v-shaped oval base 110 and a suction cup 120. The v-shaped oval base 110 is a v-shaped spiraling coil 112 with a bottom portion 114 and a top portion 116 that can receive a top portion TP of a bottle B to removably secure the top portion TP of the bottle B in an inverted position to have a content C of the bottle B flow downward by gravity to the inverted top portion TP of the bottle B. Typically the content C of the bottle B are a liquid, a gel, a fluid, a powder or other suitable substance. The bottom portion 114 is relatively much narrower than the relatively wider top portion 116. The v-shaped oval base 110 accommodates and fits the general shape of the top portion TP of the bottle B or any other suitable shaped receptacle.

The suction cup 120 has a rounded top portion 122 and a horizontal bottom portion 124 to stabilize and secure the receptacle liquid extractor 100. The suction cup 120 can also be replaced with a weighted base 130 to stabilize and secure the receptacle liquid extractor 100. The rounded top portion 122 of the suction cup 120 is attached to the bottom portion 114 of the v-shaped oval base 110 forming the receptacle liquid extractor 100. The horizontal bottom portion 124 is horizontally flat 126 and provides suction to an attachment surface AS to secure the receptacle liquid extractor 100. The attachment surface AS is typically a flat and clean surface and can be a countertop, a table or another suitable surface. The suction cup 120 is made of silicone but can be made of any other suitable material such as rubber or plastic.

The receptacle liquid extractor 100 is approximately in the range of 3 inches to 4 inches in height, in the range of 2 inches to 3 inches in width and in the range of 1.5 inches to 2 inches in depth, although the receptacle liquid extractor 100 can be any relatively larger suitable size or any relatively smaller suitable size.

The receptacle liquid extractor is a container holding a liquid or other suitable substance that introduces a storage unit designed to use gravity to ensure the entire use of bottle content. Comprised of a V-shaped spiraling coil that possesses a suction cup or an alternative weighted bottom, the receptacle liquid extractor positions a contained liquid to flow according to the curve of the bottom of the receptacle resulting in easy access and full product use, with each engagement of a pump or a squeezing mechanism. The receptacle liquid extractor may be readily available at renowned household and commercial decor retailers. The receptacle liquid extractor offers a relatively clever yet simplistic method to utilizing bottle content. The receptacle liquid extractor can securely hold varying sized containers and effectively reduces unnecessary waste of the contained liquids.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A receptacle liquid extractor, comprising:
a v-shaped oval base with a bottom portion and a top portion, said v-shaped oval base receives a top portion of a bottle to removably secure said top portion of said bottle, said bottle is in an inverted position to have a content of said bottle flow downward by gravity to said top portion of said bottle; and
a suction cup with a rounded top portion and a horizontal bottom portion, said suction cup stabilizes and secures said receptacle liquid extractor, said rounded top portion of said suction cup is attached to said bottom portion of said v-shaped oval base forming said receptacle liquid extractor, said horizontal bottom portion is horizontally flat, said horizontal bottom portion provides suction to an attachment surface, said horizontal bottom portion to secure said receptacle liquid extractor to said attachment surface.

2. The receptacle liquid extractor according to claim 1, wherein said v-shaped oval base is a v-shaped spiraling coil.

3. The receptacle liquid extractor according to claim 1, wherein said content is a liquid.

4. The receptacle liquid extractor according to claim 1, wherein said content is a gel.

5. The receptacle liquid extractor according to claim 1, wherein said content is a fluid.

6. The receptacle liquid extractor according to claim 1, wherein said content is a powder.

7. The receptacle liquid extractor according to claim 1, wherein said bottom portion of said v-shaped oval base is much narrower than said wider top portion of said v-shaped oval base.

8. The receptacle liquid extractor according to claim 1, wherein said v-shaped oval base accommodates and fits said top portion of said bottle.

9. The receptacle liquid extractor according to claim 1, wherein said suction cup is replaced with a weighted base, said weighted base to stabilize and secure said receptacle liquid extractor.

10. The receptacle liquid extractor according to claim 1, wherein said attachment surface is a flat and clean surface.

11. The receptacle liquid extractor according to claim 1, wherein said attachment surface is a selected one of a countertop and a table.

12. The receptacle liquid extractor according to claim 1, wherein said suction cup is made of silicone.

13. The receptacle liquid extractor according to claim 1, wherein said suction cup is made of rubber.

14. The receptacle liquid extractor according to claim 1, wherein said suction cup is made of plastic.

15. A receptacle liquid extractor, comprising:
a v-shaped oval base with a bottom portion and a top portion, said v-shaped oval base receives a top portion of a bottle to removably secure said top portion of said bottle, said bottle is in an inverted position to have a content of said bottle flow downward by gravity to said top portion of said bottle, said v-shaped oval base is a v-shaped spiraling coil, said bottom portion of said v-shaped oval base is much narrower than said wider top portion of said v-shaped oval base, and said v-shaped oval base accommodates and fits said top portion of said bottle; and
a suction cup with a rounded top portion and a horizontal bottom portion, said suction cup stabilizes and secures said receptacle liquid extractor, said rounded top portion of said suction cup is attached to said bottom portion of said v-shaped oval base forming said receptacle liquid extractor, said horizontal bottom portion is horizontally flat, said horizontal bottom portion provides suction to an attachment surface, said horizontal bottom portion to secure said receptacle liquid extractor to said attachment surface, said attachment surface is a flat and clean surface, and said attachment surface is a selected one of a countertop and a table.

16. The receptacle liquid extractor according to claim 15, wherein said content is a selected one of a liquid, a gel, a fluid and a powder.

17. The receptacle liquid extractor according to claim 15, wherein said suction cup is replaced with a weighted base, said weighted base to stabilize and secure said receptacle liquid extractor.

18. The receptacle liquid extractor according to claim 15, wherein said suction cup is a selected one made of a silicone, a rubber and a plastic.

19. The receptacle liquid extractor according to claim 15, wherein said receptacle liquid extractor is approximately in the range of 3 inches to 4 inches in height and is approximately in the range of 2 inches to 3 inches in width.

20. The receptacle liquid extractor according to claim 15, wherein said receptacle liquid extractor is approximately in the range of 1.5 inches to 2 inches in depth.
